(19) United States
(12) Patent Application Publication
(10) Pub. No.: US 2023/0192956 A1
(43) Pub. Date: Jun. 22, 2023

(54) FILM, MULTILAYER ELECTRONIC DEVICE, AND MANUFACTURING METHOD OF THE FILM

(71) Applicant: SKC Co., Ltd., Suwon-si (KR)

(72) Inventors: Han Jun KIM, Suwon-si (KR); Jin Yong LEE, Suwon-si (KR); Jin Woo LEE, Suwon-si (KR); Dae Seong OH, Suwon-si (KR)

(73) Assignee: SKC Co., Ltd., Suwon-si (KR)

(21) Appl. No.: 17/967,153

(22) Filed: Oct. 17, 2022

(30) Foreign Application Priority Data
Dec. 20, 2021 (KR) 10-2021-0182855

(51) Int. Cl. C08G 73/10

(52) U.S. Cl. CPC C08G 73/1067

(57) ABSTRACT

The present disclosure discloses a film including a polyimide layer including an aromatic diamine compound residue and an aromatic dianhydride compound residue, wherein the polyimide layer has a loop stiffness value of 3 to 4.5 m/N based on a thickness of the polyimide layer of 50 μm.

### CROSS-REFERENCE TO RELATED APPLICATIONS

This application claims the benefit under 35 U.S.C. 119(a) of Korean Patent Application No. 10-2021-0182855 filed on Dec. 20, 2021 in the Korean Intellectual Property Office, the entire disclosure of which is incorporated herein by reference for all purposes.

### BACKGROUND

### 1. Field

The present disclosure relates to a film excellent in all characteristics of heat resistance, optical properties, and adhesion force by having a polyimide layer, thus may be conveniently used as a supporting layer of a foldable display, a multilayer electronic device including the film, and a manufacturing method of the film.

### 2. Description of Related Art

A polyimide film has excellent heat resistance and mechanical properties and thereby has wide utilization such as a coating material and a composite material. Conventionally, such a polyimide film is being manufactured by applying a composition made from solution polymerization of an aromatic diamine and an aromatic dianhydride, drying it at a high temperature to be a film shape, and subsequently performing ring closure of the aromatic diamine and the aromatic dianhydride through dehydration.

Because the characteristic of yellow color of a polyimide film due to a high density of an aromatic ring, a polyimide film has a low transmissivity in an area of visible rays, thus it is difficult to use a polyimide film as an optical material. However, recently, a colorless and transparent polyimide film is manufactured and various trials for applying it as an optical material and the like can be made.

### SUMMARY

In one general aspect, the film according to one embodiment includes a polyimide layer including an aromatic diamine compound residue and an aromatic dianhydride compound residue, wherein the polyimide layer has a loop stiffness value of 3 to 4.5 m/N based on a thickness of the polyimide layer of 50 μm.

The polyimide layer may have a heat resistance stability index (HS index) of 5 to 15° C.²/ppm·MPa according to Equation 1 below:

$$HS index = \frac{Tg \times 10}{H \times RS} \qquad [ Equation 1 ]$$

In Equation 1, HS index is a heat resistance stability index (° C.²/ppm·MPa), Tg is a glass transition temperature (° C.), H is a coefficient of a thermal expansion value (ppm/° C.) of the polyimide layer, and RS is a residual stress value (MPa) of the polyimide layer.

The polyimide layer may have an adhesion force of 200 gf/inch or more.

The polyimide layer may have a yellow index of 5.3 or less.

The polyimide layer may have a composite index of 2° C.²/ppm or more expressed by Equation 2 below:

$$T I ndex = \frac{Tg}{H \times Y 1} \qquad [ Equation 2 ]$$

In Equation 2, T Index is a composite index, Tg is a glass transition temperature (° C.),YI is a yellow index in a thickness of 10 μm of the polyimide layer, and H is a coefficient of thermal expansion (ppm/° C.) value of the polyimide layer.

The polyimide layer may include a biphenyltetracarboxylic acid dianhydride residue of 5 to 45 mol, when a total amount of the aromatic dianhydride compound residue is 100 mol.

The polyimide layer may include a biphenyltetracarboxylic acid dianhydride residue and a pyromellitic dianhydride residue.

An amount of the biphenyltetracarboxylic acid dianhydride residue may be 15 to 50 mol % based on a sum of numbers of moles of the biphenyltetracarboxylic acid dianhydride residue and pyromellitic dianhydride residue.

An amount of the pyromellitic dianhydride residue may be less than 60 mol % when an amount of the aromatic dianhydride compound residue is 100 mol.

In another general aspect, the multilayer electronic device according to another embodiment includes a substrate layer; and a radiant functional layer, wherein the substrate layer includes the film described above.

In still another general aspect, the method of manufacturing the film includes: preparing a polymer solution by stirring a raw material composition including an aromatic diamine compound and an aromatic dianhydride compound to prepare the polymer solution with a viscosity of 1,000 to 8,000 cps measured at 25° C.; preparing a sheet by applying the polymer solution in a sheet form and drying the polymer solution with a hot wind to prepare the sheet; and preparing the film by thermally treating the sheet, wherein the polyimide layer includes an aromatic diamine compound residue and an aromatic dianhydride compound residue, and wherein the polyimide layer has a loop stiffness value of 3 to 4.5 m/N based on a thickness of the polyimide layer of 50 μm.

The film may be thermally treated at a temperature of at 360 to 480° C.

The stirring may include a primary stirring, a secondary stirring, and a tertiary stirring.

The primary stirring may include stirring the aromatic diamine compound and a first aromatic dianhydride compound, and wherein the aromatic diamine compound and the first aromatic dianhydride compound are represented by the following Formula 1 and 2-1, respectively:

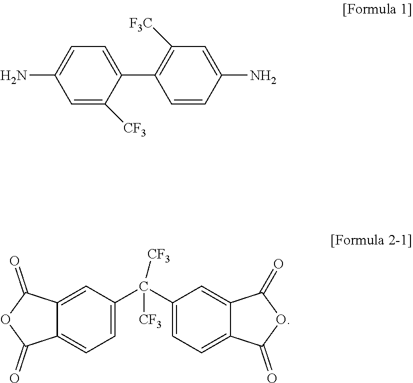 [SMILES: Nc1ccc(-c2ccc(N)cc2C(F)(F)F)c(C(F)(F)F)c1 ; O=C1OC(=O)c2cc(C(c3ccc4c(c3)C(=O)OC4=O)(C(F)(F)F)C(F)(F)F)ccc21]

The primary stirring may be performed for a reaction time of 1 hour to 7 hours at a reaction temperature of 5 to 15° C.

The secondary stirring may include stirring a reaction product of the primary stirring and a second aromatic dianhydride compound, wherein the second aromatic dianhydride compound is represented by the following Formula 2-2:

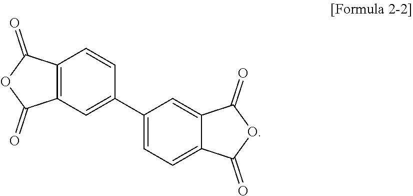 [SMILES: O=C1OC(=O)c2cc(-c3ccc4c(c3)C(=O)OC4=O)ccc21]

The secondary stirring may be performed for a reaction time of 30 minutes to 10 hours at a reaction temperature of 30 to 70° C.

The tertiary stirring may include stirring a reaction product of the secondary stirring and a third aromatic dianhydride compound, wherein the third aromatic dianhydride compound is represented by the following Formula 2-3:

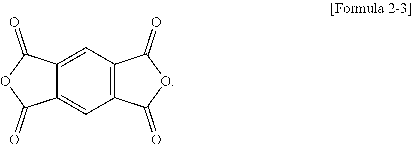 [SMILES: O=c1oc(=O)c2cc3c(=O)oc(=O)c3cc12]

The tertiary stirring may be performed for a reaction time of 30 minutes to 10 hours at a reaction temperature of 30 to 70° C.

The raw material composition or the polymer solution may further include a leveling stabilizer.

The film may include the polyimide layer, wherein the polyimide layer includes an aromatic diamine compound residue and an aromatic dianhydride compound residue, and wherein the polyimide layer has a loop stiffness value of 3 to 4.5 m/N based on a thickness of 50 μm.

Other features and aspects will be apparent from the following detailed description and the claims.

### BRIEF DESCRIPTION OF THE DRAWINGS

FIG. 1 and FIG. 2 are conceptual sectional views for illustrating layer structures of the film according to one embodiment, respectively.

FIG. 3 and FIG. 4 are conceptual sectional views for illustrating layer structures of the multilayer electronic device according to one embodiment, respectively.

FIG. 5A and FIG. 5B are conceptual sectional views for illustrating a process of an adhesive test.

FIG. 6A and FIG. 6B are conceptual sectional views for illustrating a process of a loop stiffness test.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

In this disclosure, the phrase that a certain element “comprises” or “includes” another element means that the certain element may further include one or more other elements but does not preclude the presence or addition of one or more other elements, unless stated to the contrary.

In this disclosure, when an element is referred to as being “connected” to another element, it can be understood not only as a case of a certain element directly connected to the other element but also as a case of having other elements interposed therebetween.

In this disclosure, “B being placed on A” means that B is placed in direct contact with A or placed over A with another layer or structure interposed therebetween and thus should not be interpreted as being limited to B being placed in direct contact with A.

Throughout this disclosure, the phrase “combination(s) thereof” included in a Markush-type expression denotes one or more mixtures or combinations selected from the group consisting of components stated in the Markush-type expression, that is, denotes one or more components selected from the group consisting of the components are included.

Throughout this disclosure, the description of “A and/or B” means “A, B, or A and B.”

Throughout this disclosure, terms such as “first”, “second”, “A”, or “B” are used to distinguish the same terms from each other unless specially stated otherwise.

In this disclosure, a singular form is contextually interpreted as including a plural form as well as a singular form unless specially stated otherwise.

In this disclosure, the relative size, thickness, and the like of a component expressed in a drawing may be expressed exaggeratedly for convenience in descriptions.

In this disclosure, the yellow index (Y.I.) is expressed by using CIE color system of a spectrometer (UltraScan PRO available from Hunter Associates Laboratory corporation) and based on a value calculated in ASTM E-313 standard.

In this disclosure, the viscosity disclosed without special description of a temperature refers to a viscosity measured at a room temperature, and for example, refers to a viscosity measured at 25° C.

Hereinafter, the present disclosure will be described in further detail.

A polyimide film has a color close to a brown when having an excellent heat resistance, whereas a polyimide film is transparent when having degraded heat resistance. That is, the heat resistance and transparence may be traded off against each other.

A polyimide film is used as an insulating layer of an electronic product based on its insulating characteristics. Also, based on foldable or flexible characteristics and an insulating characteristic, attempts have been made to apply a polyimide film to a flexible display or a foldable display.

A film applied as a supporting layer of a display is required to withstand a harsh environment such as being exposed to a high temperature environment repetitively during a process of manufacturing a display. Additionally, for getting stable properties of other layers laminated on the supporting layer, the residual stress of the film must be controlled, and the film should have a characteristic of controlled thermal expansion and the like.

In addition, a polyimide layer requires a capacity of recovering by a proper elasticity as well as a capacity of being folded flexibly. The inventors manufactured a film having a polyimide layer satisfying various contrary characteristics required when applied as a supporting layer of a display, confirmed the characteristics thereof, and thereby disclose embodiments.

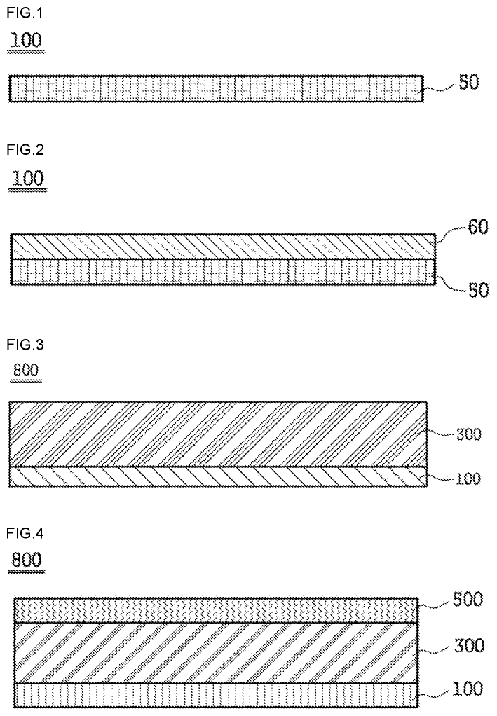

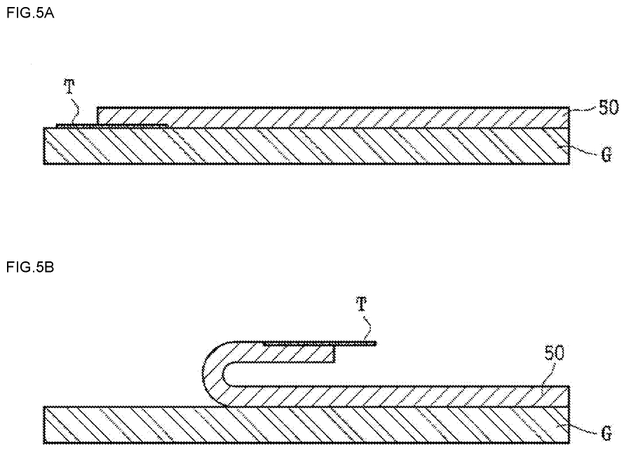

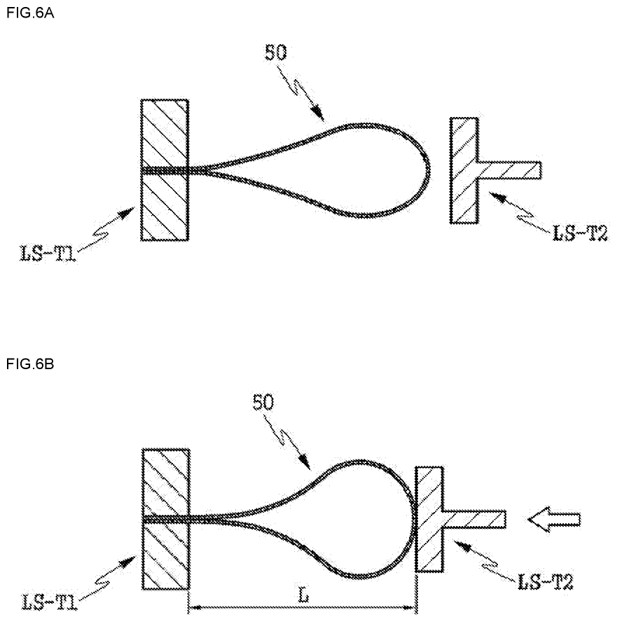

FIG. 1 and FIG. 2 are sectional conceptual views for illustrating layer structures of the film according to one embodiment, respectively, FIG. 3 and FIG. 4 are sectional conceptual views for illustrating layer structures of the multilayer electronic device according to one embodiment, respectively, FIG. 5A and FIG. 5B are a sectional conceptual view for illustrating a process of an adhesive test, and FIG. 6A and FIG. 6B are a sectional conceptual view for illustrating a process of a loop stiffness test.

With reference to FIGS. 1 to 6, descriptions of the multilayer electronic device 800 and the film applied as a substrate layer 100 will be made in detail below.

### Film

Referring to FIG. 1, the film according to one embodiment includes a polyimide layer 50.

The polyimide layer 50 includes an aromatic diamine compound residue and an aromatic dianhydride compound residue.

The polyimide layer 50 may have an excellent loop stiffness characteristic.

The polyimide layer 50 with a thickness of 50 μm may have a loop stiffness value of 3 to 4.5 m/N. The polyimide layer 50 with a thickness of 50 μm may have a loop stiffness value of 3.1 to 4.2 m/N. The polyimide layer 50 with a thickness of 50 μm may have a loop stiffness value of 3.2 to 4.1 m/N.

In such a case, the polyimide layer has an excellent recovery force against bending and may have further excellent restitutive force against folding when applied to a bendable or rollable multilayer electronic device.

The loop stiffness may be measured by a loop stiffness tester available from TOYOSEIKI corporation. A polyimide film sample with a thickness of 50 μm is prepared to have a width of 15 mm and a length of 120 mm, and both ends thereof are fixed to a fixing unit. Subsequently, the sample is pressurized at the pressurizing speed of 3.3 mm/s by a pressurizing unit to have a final distance (L) of 20 mm between the pressurizing unit and the fixing unit. After that, the loop stiffness of the sample may be measured. Referring to FIG. 6A and FIG. 6B, in the embodiment, the loop stiffness measured in MD (Mechanical Direction), which is length direction, of a film is considered as a reference.

The polyimide layer 50 may have a heat resistance stability index (HS index), which may be calculated by the following [Equation 1], of 5 to 15° C.²/ppm·MPa:

$$HS index = \frac{Tg \times 10}{H \times RS} \qquad [ Equation 1 ]$$

In Equation 1, HS index is a heat resistance stability index (° C.²/ppm·MPa), Tg is a glass transition temperature (° C.), H is a coefficient of a thermal expansion value of the polyimide layer, and RS is a residual stress value of the polyimide layer.

The polyimide layer may have a heat resistance stability index of 5° C.²/ppm·MPa or more. The heat resistance stability index may be 6° C.²/ppm·MPa or more. The heat resistance stability index may be 7° C.²/ppm·MPa or more. The heat resistance stability index may be 7.3° C.²/ppm·MPa or more. The heat resistance stability index of the polyimide layer may be 15° C.²/ppm·MPa or less. The heat resistance stability index may be 13° C.²/ppm·MPa or less.

When the polyimide layer has a heat resistance stability index as above, it has a low coefficient of thermal expansion and a low residual stress while having a relatively high glass transition temperature, and thereby the polyimide layer is great to be used as a supporting layer of a multilayer electronic device.

The polyimide layer 50 may have an adhesion force of 200 gf/inch or more. The adhesion force may be 220 gf/inch or more. The adhesion force may be 230 gf/inch. The polyimide layer 50 may have an adhesion force of 350 gf/inch or less. The adhesion force may be 330 gf/inch or less. The adhesion force may be 300 gf/inch or less. The adhesion force may be 280 gf/inch or less.

When the polyimide layer has an adhesion force as above, the polyimide layer has an adhesion force with a component like a radiant functional layer and the like in a proper level, and may have excellent characteristics for a substrate of a multilayer electronic device.

The adhesion force may be measured by a method for testing the adhesion force of a polyimide layer. For example, the adhesion force may be measured through a peeling test, which may be conducted by using UTM (Universal Testing Machine), after a polyimide layer is formed (cured) on an amorphous Si (silicon) glass substrate. In detail, some parts of the polyimide layer are peeled off by using a tape or the like to perform a peeling test at 180°. At this time, the adhesion force may be measured by using UTM. Referring to FIG. 5A and FIG. 5B, as a further detailed condition, the condition disclosed in an embodiment described below may be applied.

The polyimide layer 50 may have a composite index of 2° C.²/ppm or more expressed by Equation 2 below:

$$T Index = \frac{Tg}{H \times Y 1} \qquad [ Equation 2 ]$$

In Equation 2, T Index is a composite index, Tg is a glass transition temperature (° C.), YI is a yellow index in the thickness of 10 μm of the polyimide layer, and H is a coefficient of thermal expansion (ppm/° C.) value of the polyimide layer.

The polyimide layer 50 may have a composite index of 2° C.²/ppm or more. The composite index may be 2.2° C.²/ppm or more. The composite index of the polyimide layer 50 may be 15° C.²/ppm or less. The composite index may be 10° C.²/ppm or less. The composite index may be 7° C.²/ppm or less.

The polyimide layer 50 may have a coefficient of thermal expansion (ppm/° C.²) of 35 or less. The coefficient of thermal expansion (ppm/° C.²) may be 30 or less. The polyimide layer 50 may have a coefficient of thermal expansion (ppm/° C.²) of 27 or less. The coefficient of thermal expansion (ppm/° C.²) may be 25 or less. Also, the polyimide layer 50 may have a coefficient of thermal expansion (ppm/° C.²) of 10 or more. The coefficient of thermal expansion (ppm/° C.²) may be 15 or more.

When having such a coefficient of thermal expansion value, the polyimide layer has a small variation in the volume depending on temperature change, and the film is great for application as a substrate of a multilayer electronic device.

The measurement of residual stress may be conducted by applying a measuring method of residual stress of a polyimide film. In detail, the residual stress may be measured by using 500TC (FSM 128) available from Frontier Semiconductor corporation. In detail, a polyimide layer is formed on a 6-inched silicon wafer, for which the degree of bending has been measured beforehand. After that, by comparing difference of bending degree, a residual stress may be measured. A further detailed method is based on the method described in an embodiment described below.

The residual stress of the polyimide layer 50 may be 25 MPa or less. The residual stress may be 22 MPa or less. The residual stress may be 20 Mpa or less. The residual stress of the polyimide layer 50 may be 18 Mpa or less. The residual stress may be 16 Mpa or less. The residual stress of the polyimide layer 50 may be 10 Mpa or more.

When having such a characteristic in residual stress, the polyimide layer may be conveniently used as a supporting layer of a multilayer electronic device.

When laminating element in a multilayer structure, a stress, which is caused from physical inharmony in the interface adjacent to the surface of the polyimide layer, may occur. This may cause a problem such as a crack, dislocation, or delamination between layers in a laminate. This may cause a serious problem in reliability of a product itself as well as a manufacturing process of a multilayer electronic device. Accordingly, for applying the polyimide film as a supporting layer, the polyimide film must have a stable characteristic even in a process of repetitively exposing to a temperature of 350 to 400° C. As one of various references for evaluating the above characteristic, residual stress may be applicable. Such a residual stress is thought to be caused from various factors such as a high temperature applied in a manufacturing process of a polyimide film (polyimide layer), a difference in coefficient of thermal expansion with a supporting substrate, and a stiffness of a polymer chain itself. The present disclosure applies the method described below and thereby maintains other characteristics to be a certain level or more while lowering the residual stress.

The polyimide layer 50 may have a thickness of 2 to 100 μm. The thickness may be 2 to 55 μm. The thickness may be more than 2 μm and less than 40 μm.

The polyimide layer 50 has an even thickness overall. In detail, when the polyimide layer 50 is divided into forty sections substantially having equivalent areas, thicknesses measured from forty points chosen by one point per area have a value in the range of −5 to +5% compared to the average value of thicknesses measured from the forty points, and the polyimide layer 50 has great uniformity in the thickness.

The polyimide layer 50 has an excellent characteristic in heat resistance.

The polyimide layer 50 may have a glass transition temperature of 365° C. or more. The glass transition temperature may be 370° C. or more. The glass transition temperature may be 375° C. or more. The polyimide layer 50 may have a glass transition temperature of 390° C. or less. The glass transition temperature is based on the result measured by using DMA (Dynamic Mechanical Analyzer) measuring device. For example, the DMA measuring device is DMA Q800 model available from Texas Instruments corporation. Additionally, as the measuring mode, Tension Mode may be applied. Specifically, a temperature is increased at the heating speed of 3° C./min and increased from 25 to 450° C. for measurement, and at this time, the frequency of 1 Hz and the amplitude of 20 μm are applied to obtain a Tg value.

The polyimide layer 50 has excellent optical properties.

Yellow index is measured by using CIE (Commission internationale de l'éclairage, International Commission on Illumination) color system of a spectrometer (UltraScan PRO available from Hunter Associates Laboratory corporation) according to ASTM E-313 standard.

The polyimide layer 50 may have a yellow index of 5.3 or less. The yellow index may be 4.3 or less. The yellow index may be 4.1 or less. The polyimide layer 50 may have a yellow index of more than 1. The measurement of yellow index of the polyimide layer is based on a value measured from a film with a thickness of 10 μm.

An in-plane retardation value is measured by choosing Alpha/Theta mode from Rotate Analyzer Method at a room temperature by using RETS-100 model available from OTSUKA Electronics corporation, and based on the in-plane retardation Re value measured with light of 550 nm wavelength. The measurement of an in-plane retardation of the polyimide layer is based on a value measured from a film with a thickness of 10 μm.

The polyimide layer 50 may have an in-plane retardation value Re of 3.0 or less. The in-plane retardation value Re may be 2.0 or less. The in-plane retardation value Re may be 2.0 or less. The in-plane retardation value Re may be 1.5 or less. The in-plane retardation value Re may be 1.0 or less. The polyimide layer 50 may have an in-plane retardation value Re of 0.1 or more. The polyimide layer having an in-plane retardation value in the rage described above may have excellent optical properties suitable for being applied to a display.

The polyimide layer 50 may have a light transmissivity of 85% or more. The light transmissivity may be 88% or more. The light transmissivity may be 99% or less. The light transmissivity is based on the transmissivity of a visible ray measured from a film with a thickness of 10 μm.

The polyimide layer 50 may have haze of 1% or less. The haze may be 0.6% or less. The haze may be 0.52% or less. The haze may be 0.45% or less. The polyimide layer 50 may have haze of 0.001% or more. A polyimide layer having such a haze characteristic has an optical characteristic of being seen clearly with a naked eye and is great to be applied as a substrate layer of a display or the like. The haze is based on a value measured from a film with a thickness of 10 μm.

The polyimide layer 50 includes a polymer formed by polymerizing an aromatic diamine compound and an aromatic dianhydride compound. That is, the polyimide layer includes an aromatic diamine compound residue and an aromatic dianhydride compound residue.

The aromatic diamine compound may include 2,2′-bis(trifluoromethyl)-4,4′-diaminobiphenyl (TFMB), 2,2-bis(4-(4-aminophenoxy)phenyl)hexafluoropropane (HFBAPP) , 4,4′-diamino-2,2′-bis(trifluoromethyl)diphenyl ether (BTFDPE), 2,2-bis(4-(4-amino-2-(trifluoromethyl)phenoxy) cy)phenyl)hexafluoropropane (HFFAPP), or 3,5-diaminobenzotrifluoride (DATF).

In detail, the aromatic diamine compound may be a compound expressed by Formula 1 below:

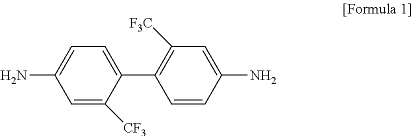 [SMILES: Nc1ccc(-c2ccc(N)cc2C(F)(F)F)c(C(F)(F)F)c1]

Two kinds or more of the aromatic dianhydride compound may be applied, preferably three kinds selected from the group consisting of 2,2-bis (3,4-dicarboxyphenyl) hexafluoropropane dianhydride (6-FDA), 4,4′-oxydiphthalic anhydride (ODPA), 2,3,3′,4′-biphenyltetracarboxylic acid dianhydride (BPDA), pyromellitic dianhydride (PMDA), and combinations thereof.

Specifically, the aromatic dianhydride compound may be compounds selected from the group consisting of Formulas 2-1 to 2-3 below:

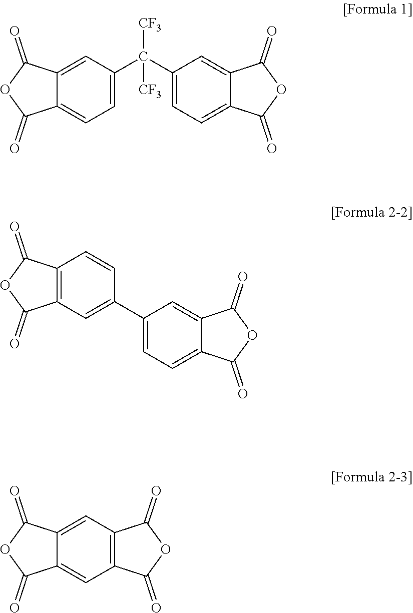 [SMILES: O=C1OC(=O)c2cc(C(c3ccc4c(c3)C(=O)OC4=O)(C(F)(F)F)C(F)(F)F)ccc21 ; O=C1OC(=O)c2cc(-c3ccc4c(c3)C(=O)OC4=O)ccc21 ; O=c1oc(=O)c2cc3c(=O)oc(=O)c3cc12]

The aromatic diamine compound and the aromatic dianhydride compound may react in a molar ratio of 1:0.95 to 1.05 to form a polymer.

The polyimide layer 50 may include a biphenyltetracarboxylic acid dianhydride residue of Formula 2-3 in a ratio of 5 to 45 mol, when a total amount of an dianhydride residue is designated as 100 mol. The polyimide layer 50 may include the biphenyltetracarboxylic acid dianhydride residue of Formula 2-3 in a ratio of 8 to 30 mol, when a total amount of the dianhydride residue is designated as 100 mol. A polyimide layer having the compound residue of Formula 2-3 may improve a heat resistance characteristic, workability, and the like further.

The polyimide layer 50 includes a biphenyltetracarboxylic acid dianhydride residue and a pyromellitic dianhydride residue, and based on a sum of the number of moles of the biphenyltetracarboxylic acid dianhydride residue and the pyromellitic dianhydride residue, an amount of the biphenyltetracarboxylic acid dianhydride residue may be a 15 to 50 mol %. The polyimide layer 50 includes the biphenyltetracarboxylic acid dianhydride residue and the pyromellitic dianhydride residue, and based on the sum of the number of moles of the biphenyltetracarboxylic acid dianhydride residue and pyromellitic dianhydride residue, the amount of biphenyltetracarboxylic acid dianhydride residue may be 18 to 45 mol %. When the residue is included in such a range, it is possible to improve heat resistance and optical properties that are traded off against each other, in addition to controlling viscosity to have great workability during a manufacturing process.

The polyimide layer 50 may have the pyromellitic dianhydride residue in an amount of less than 60 mol % based on 100 mol of aromatic dianhydride residue. The polyimide layer 50 may have the pyromellitic dianhydride residue in an amount of less than 55 mol % based on 100 mol of aromatic dianhydride residue. When including the pyromellitic dianhydride residue in an amount of such a range, a polyimide layer may be relatively advantageous in viscosity control and the like, thereby having proper workability and an improved heat resistance characteristic.

The polyimide layer may include the residue of Formula 2-1 in an amount of 25 to 55 molar ratio, the residue of Formula 2-2 in an amount of 35 to 55 molar ratio, and the residue of Formula 2-3 in an amount of 5 to 25 molar ratio, based on 100 mole of the aromatic diamine compound residue.

The polyimide layer including the residues in such a molar ratio, may have excellent heat resistance and optical properties.

The polyimide layer 50 may include a compound having a hydroxyl group. This may be detected by a residual compound applied as a leveling stabilizer in a manufacturing process described below. Such a leveling stabilizer and the like help the formation of a more uniform film, which makes the manufacturing process of the polyimide layer easier, and this can influence improvement in a heat resistance characteristic, a residual stress characteristic, an adhesion force, and the like of the film.

The leveling stabilizer may be selected from the group consisting of methanol, ethanol, butanol, propanol, and combinations thereof, and may be methanol or isopropanol. When the above compound is applied as the leveling stabilizer, it is possible to obtain effects of more stable film formation, improvement in residual stress, and the like, while maintaining the optical properties or heat resistance.

Referring to FIG. 2, the film may further include an adhesive layer 60 on one side of the polyimide layer.

The adhesive layer 60 may be applied by an adhesive layer with excellent light transmittance and/or transparency for optics. For example, a laminate including OCA (Optically Clear Adhesive), PSA (Pressure Sensitive Adhesive), or a combination thereof may be applied.

The film may include a release film or a reinforcing film on the other side of the polyimide layer further. The release film or the reinforcing film may be a polyethylene phthalate film (PET film) or the like, but the film is not limited thereto.

The film includes a polyimide layer described above, and functions as a supporting layer while simultaneously satisfying a heat resistance characteristic and optical properties, thereby having great utilization as a substrate layer. In addition, when the film is used as a substrate layer, the substrate layer corresponding to the rear side of a multilayer electronic device may also be manufactured to be transparent, as well as a radiant functional layer corresponding to the front of the multilayer electronic device. Through this, it is possible to provide a film having reliability in all the characteristics of heat resistance, thickness, insulating, supporting, and the like in addition to having great utilization to foldable, flexible, bendable apparatus.

### Multilaver Electronic Device

Referring to FIG. 2, in one general aspect, the multilayer electronic device 800 according to one embodiment of the present disclosure includes a substrate layer 100; and a radiant functional layer 300 disposed on the substrate layer 100. Referring to FIG. 4, the multilayer electronic device 800 may include a cover layer 500 disposed on the radiant functional layer 300.

The substrate layer 100 further includes the film described above.

The multilayer electronic device 800 may be a display device.

The multilayer electronic device 800 may be for example, a large size display device, a foldable display device, a bendable display device, or a flexible display device.

The multilayer electronic device 800 may be for example, a bendable mobile communication device (e.g., mobile phone) or a bendable laptop.

The radiant functional layer 300 includes a colorized layer (not shown) having an element emitting light depending on signals. For example, the radiant functional layer may include a signal transmitting layer (not shown) for transmitting an external electronic signal to the colorized layer, the colorized layer (not shown) disposed on the signal transmitting layer and being colorized depending on given signals, and an encapsulation layer (not shown) for protecting the colorized layer. The signal transmitting layer (not shown) may include a thin film transistor (TFT), and for example, LTPs (Low Temperature Poly Silicon), a-SiTFT, or Oxide TFT may be applied, but the layer is not limited thereto. The encapsulation layer (not shown) may be TFE (Thin Film Encapsulation), but the layer is not limited thereto.

The colorized layer may be a colorized layer with self-lighting property. For example, the colorized layer may be QLED (Quantum dot light-emitting diodes), OLED (Organic Light Emitting Diodes), or the like, but the layer is not limited thereto.

The radiant functional layer 300 may include a sensor layer (not shown). For example, a touch sensor may be applied. The sensor layer may be disposed on or under the colorized layer.

The radiant functional layer 300 may further include a polarized layer (not shown). The polarized layer may be disposed on or under the colorized layer.

The radiant functional layer 300 may include a color filter layer (not shown). The color filter layer may be disposed on or under the colorized layer.

The radiant functional layer 300 may be disposed on the substrate layer 100.

A cover layer 500 may be disposed on the radiant functional layer 300.

As the cover layer 500, a plastic film, a glass, or the like applicable as a cover layer of a display device may be used.

An adhesive layer (not shown) may be applied further between the radiant functional layer 300 and the cover layer 500.

The cover layer 500 may further include an electrode layer (not shown), depending on the type of a light emitting element. The electrode layer is disposed on one side of the radiant functional layer, and between the electrode layer and the radiant functional layer, an optical adhesive layer may be optionally disposed. The electrode layer may be a transparent metal layer, and preferably, a transparent metal layer having sealing functionality. The electrode layer may induce driving of a light emitting layer of the radiant functional layer while transmitting a light emitted from the radiant functional layer. For example, the electrode layer may be applied as a cathode of the radiant functional layer. When the multilayer electronic device has a signal transmitting layer under the other side of the light emitting layer and an electrode layer on one side of the light emitting layer together, the structure of the multilayer electronic device is preferable to include a radiant functional layer like OLED.

The substrate layer 100 includes the polyimide layer 50.

The substrate layer 100 may include the polyimide layer 50 and an adhesive layer 60 disposed on the polyimide layer.

The adhesive layer 60 may be an adhesive layer for optics with excellent light transmissivity and/or transparence. For example, the adhesive layer may be a laminate including OCA (Optically Clear Adhesive), PSA (Pressure Sensitive Adhesive), or a combination thereof.

The detailed description of the film and the polyimide layer is overlapped with the above description and thus the further description is omitted.

As needed, the multilayer electronic device may further include an additional border layer (now shown) under the substrate layer, or may be further connected to a supporting mean (or driving mean) of a rollable or bendable display.

As needed, an additional driving mean (or supporting mean) of a rollable or bendable display may be further connected to the cover layer of the multilayer electronic device.

Any driving mean or supporting mean ordinarily applied to a rollable or bendable display is applicable without limitation.

The multilayer electronic device 800 may have a light transmittance of 85% or more. The light transmittance may be 90% or more. The light transmittance may be 99% or less. The measurement of light transmittance may be made in a similar method to the measurement of light transmittance of the polyimide layer.

### Manufacturing Method of Film

The manufacturing method of the film according to one embodiment includes an operation of manufacturing a polymer solution; an operation of manufacturing a sheet; and an operation of manufacturing the film.

An operation of manufacturing the polymer solution is an operation of stirring a raw material composition including diamine and dianhydride to manufacture the polymer solution. The operation of manufacturing the polymer solution may include a reaction process and an aging process.

The diamine may be an aromatic diamine compound.

The diamine may include one kind or more of aromatic diamine compounds.

The dianhydride may be an aromatic dianhydride compound.

The dianhydride may include three kinds or more of aromatic dianhydride compounds.

The raw material composition used in the manufacture of the polymer solution may include the aromatic diamine compound and the aromatic dianhydride compound in a molar ratio of 1:0.95 to 1.05.

The raw material composition may include a biphenyltetracarboxylic acid dianhydride compound of Formula 2-3 in a molar ratio of 5 to 45 mol based on 100 mol of the dianhydride compound. The raw material composition may include a biphenyltetracarboxylic acid dianhydride compound of Formula 2-3 in a molar ratio of 8 to 30 mol based on 100 mol of the dianhydride compound. When a polyimide layer having the compound of Formula 2-3 is included in an amount of such a range, it is possible to improve a heat resistance characteristic, workability, and the like of the polyimide layer.

The raw material composition includes a biphenyltetracarboxylic acid dianhydride compound and a pyromellitic dianhydride compound. The raw material composition may have the biphenyltetracarboxylic acid dianhydride compound in an amount of 15 to 50 mol % based on a sum of numbers of moles of the biphenyltetracarboxylic acid dianhydride compound and the pyromellitic dianhydride compound. The raw material composition may have the biphenyltetracarboxylic acid dianhydride compound in an amount of 18 to 45 mol % based on a sum of numbers of moles of the biphenyltetracarboxylic acid dianhydride compound and the pyromellitic dianhydride compound. When including the compounds in such a range, the composition may improve a heat resistance characteristic and optical properties traded off against each other, while controlling viscosity to have great workability in the manufacturing process.

The raw material composition may have the pyromellitic dianhydride compound in an amount of less than 60 mol %, when the entire aromatic dianhydride compound is designated as 100 mol %. The raw material composition may have the pyromellitic dianhydride compound in an amount of 55 mol % or less, when the entire aromatic dianhydride compound is designated as 100 mol %. When the raw material composition includes the pyromellitic dianhydride compound in the amount of such a range, the composition is relatively advantageous to controlling viscosity of the raw material composition and the like, and may obtain a polyimide layer improved in a heat resistance characteristic in addition to having proper workability.

The raw material composition may include the compound of Formula 2-1 in an amount of 25 to 55 molar ratio, the compound of Formula 2-2 in an amount of 35 to 55 molar ratio, and the compound of Formula 2-3 in an amount of 5 to 25 molar ratio, based on 100 mol of the aromatic diamine compound.

The molar ratio is based on the amount of solid matter.

The reaction process is a process of stirring the raw material composition in an organic solvent and inducing imidization reaction. The product of the reaction process is referred to as a reaction solution for convenience.

In the organic solvent, the amount of solid matter in the raw material composition may be 10 to 40 wt %. The amount may be 15 to 30 wt %. The amount may be 18 to 25 wt %. When having such an amount for solid matter, the composition has further great workability.

The stirring of the raw material composition may be performed in sequence of a primary stirring, a secondary stirring, and a tertiary stirring.

The primary stirring is an operation of stirring the aromatic diamine compound including a halogen element (e.g., the compound of Formula 1) and the aromatic dianhydride compound (e.g., the compound of Formula 2-1) including another halogen element, and inducing reaction between them.

The aromatic diamine compound may be dissolved in an organic solvent (e.g., N-Methyl-2-Pyrrolidone abbreviated as NMP) in an inert atmosphere at a temperature of 20 to 45° C.

The aromatic dianhydride compound may be put into the aromatic diamine compound to conduct the primary stirring, and the primary stirring may be performed for a reaction time of 1 hour to 7 hours at a reaction temperature of 5 to 15° C.

The secondary stirring is an operation of stirring the reaction product of the primary stirring and the aromatic dianhydride compound (e.g., the compound of Formula 2-2) not including a halogen element, thereby inducing reaction between them. The secondary stirring may be performed for a reaction time of 30 minutes to 10 hours at a reaction temperature of 30 to 70° C.

The tertiary stirring is an operation of stirring the reaction product of the secondary stirring and an aromatic dianhydride compound (e.g., the compound of Formula 2-3) not including a halogen element, thereby inducing reaction between them. The tertiary stirring may be performed for a reaction time of 30 minutes to 10 hours at a reaction temperature of 30 to 70° C.

The reaction solution may be manufactured through such a process.

From the reaction solution, the polymer solution with a viscosity of 1,000 to 8,000 cps measured at 25° C., may be manufactured.

The polymer solution may further include a leveling stabilizer.

The function and type of the leveling stabilizer is the same as described above.

The leveling stabilizer may be applied in an amount of 0.01 to 5 parts by weight based on the polymer solution of 100 parts by weight. The leveling stabilizer may be applied in an amount of 0.1 to 3 pars by weight. The leveling stabilizer may be applied in an amount of 0.2 to 2 parts by weight.

The aging process is a process for forming the reaction solution into a polymer solution having a uniform viscosity and dispersing a leveling stabilizer sufficiently. The aging process may be a process of stirring for 2 to 6 hours at a temperature of 10 to 35° C.

Whether the manufacture of the polymer solution is completed may be checked by measuring viscosity of the polymer solution. The polymer solution as a precursor of the polyimide layer is required to be suitable for each coating and forming a layer with an even thickness, in addition to having excellent optical properties. Accordingly, in consideration of workability and properties, reaction of the polymer solution is preferred to be induced to have a viscosity of 1,000 to 8,000 cps, based on a value measured at 25° C. It is preferred to manufacture a polymer solution having a viscosity of 2,000 cps or more and less than 5,000 cps. The viscosity is preferred further when being equal to or more than 3,000 cps and less than 4,500 cps. When the viscosity is too low as being less than 1,000 cps, it may be difficult to manufacture the polyimide layer to have an even thickness or a desired thickness, and the heat resistance of the layer may be insufficient. When the viscosity is more than 8,000 cps, gelation may occur, and the film formation may be substantially difficult.

To the polymer solution, an additional additive and a process stabilizer may be added as needed. The additional additive and the process stabilizer may be any product applicable to the polymerization of polyimide, without limitation.

The operation of manufacturing the sheet is an operation of applying the polymer solution and drying the solution to manufacture a dried sheet.

The polymer solution is applied to a material like a glass plate, and drying thereof is conducted by applying a drying temperature and a drying time. The drying temperature may be for example, 100 to 180° C. The drying time may be 3 minutes to 60 minutes. The drying may be conducted in an inert atmosphere of a vacuum oven for controlling optical properties of the polyimide layer.

The operation of manufacturing the film is an operation of thermally treating the sheet to manufacture the polyimide film.

The thermal treatment may be conducted by applying a thermal treatment temperature and a heating speed for thermal treatment.

The thermal treatment temperature may be equal to or more than 150° C. and less than or equal to 450° C. The thermal treatment temperature may be equal to or more than 300° C. and less than or equal to 430° C. The thermal treatment temperature may be equal to or more than 360° C. and less than or equal to 400° C. The heating speed to the thermal treatment temperature may be 3 to 25° C./min. The heating speed may be 10 to 20° C./min. The heating speed may be 13 to 17° C./min.

When applying such a thermal treatment temperature and a heating speed, it is possible to control the polymerization of the manufactured film to have desired properties, and it is possible to operate more stable thermal treatment.

The thermal treatment has an advantage in that it can be conducted under an ambient atmosphere as well as under an inert atmosphere. The embodiment has a characteristic in that the process workability is more increased due to excellent optical properties even though the thermal treatment is operated in an ambient atmosphere.

The film manufactured by the manufacturing method includes the polyimide film. The polyimide film has characteristics of a polyimide layer included in the film described above.

Hereinafter, the present disclosure will be described in further detail with reference to accompanying examples. The following embodiments are only examples for understanding the present disclosure, and the range of the present disclosure is not limited to the same.

### EXAMPLES: MANUFACTURE OF POLYIMIDE LAYER

### Example 1

458 g of NMP (N-Methyl-2-Pyrrolidone) as an organic solvent was filled in a 1 L glass reactor with a temperature-controllable double jacket under a nitrogen atmosphere at 40° C. After that, 0.170 mol (100 parts by mole) of 2,2′-bis(trifluoromethyl)-4,4′-diaminobiphenyl (TFDB) as an aromatic diamine was gradually put into the reactor to be dissolved. Subsequently, 0.051 mol (30 parts by mole) of 4,4′-(hexafluoroisopropylidene)diphthalic anhydride (6-FDA) was gradually put into the reactor to be stirred for 3 hours at 10° C. (Primary stirring).

0.034 mol (20 parts by weight) of 3,3′,4,4′-biphenyltetracarboxylic anhydride (BPDA) was put into the primary stirring solution and stirred for 4 hours at 50° C., thereby manufacturing a secondary stirring solution.

0.085 mol (50 parts by weight) of PMDA (Pyromellitic dianhydride) was put into the secondary stirring solution and stirred for 4 hours at 50° C., thereby manufacturing a tertiary stirring solution.

2 parts by weight of isopropanol as a leveling stabilizer was put into 100 parts by weight of the tertiary stirring solution, and additionally stirred for 4 hours.

After viscosity of the solution was measured, an additive and a process stabilizer were additionally put into the solution to be stirred for 4 hours, thereby obtaining a polymer solution. After the polymer solution was applied to a plate glass, drying thereof was conducted for 10 minutes by a vacuum oven at 150° C. Thereafter, thermal treatment was performed. In detail, heating was performed from 150° C. to 400° C. at a rate of 15° C./min and subsequently curing was performed. Finally, a polyimide film with a thickness of 10 μm was obtained, and this was the polyimide layer of Example 1.

### Examples 2 and 3 and Comparative Examples 1 to 4

Polyimide layers of Examples 2 and 3 and Comparative Example 1 were manufactured in the same method as above and as indicated in Table 1 below.

In the cases of Comparative Examples 3 and 4, the molar ratio of a monomer was applied according to Table 1 below. However, the temperature of thermal treatment was applied to be different in Comparative Examples 3 and 4, respectively. Comparative Example 3 was heated and cured to 350° C., and Comparative Example 4 was heated and cured to 500° C.

TABLE 1

| | | | | | Comparative | Comparative | Comparative |
|---|---|---|---|---|---|---|---|
| Mole Ratio | | Example 1 | Example 2 | Example 3 | Example 1 | Example 2 | Example 3 |
| Diamine | TFMB | 100 | 100 | 100 | 100 | 100 | 100 |
| Dianhydride | 6FDA | 30 | 35 | 50 | 35 | 50 | 40 |
| | PMDA | 50 | 50 | 40 | 50 | 40 | 10 |
| | BPDA | 20 | 15 | 10 | 15 | 10 | 50 |
| Additive | Leveling | Applied | Applied | Applied | Unapplied | Unapplied | Unapplied |
| | Stabilizer | | | | | | |

| | | | | | | |
|---|---|---|---|---|---|---|
| BPDA/(PMDA + BPDA)* | 29% | 23% | 20% | 23% | 20% | 83% |
| Film Formation Test ** | ∘ | ∘ | ∘ | Δ | ∘ | Δ |

TFMB: 2,2′-bis(trifluoromethyl)-4,4′-diaminobiphenyl
6FDA: 2,2-bis(3,4-dicarboxyphenyl)hexafluoropropane dianhydride
PMDA: pyromellitic dianhydride
BPDA: 2,3,3′,4′-biphenyltetracarboxylic acid dianhydride
*Indicated to 2 decimal places.
** Film Formation Test was performed in the same manner for all the Examples and Comparative Examples, and in the process of manufacturing a polyimide layer from a polymer solution, the case of enabling manufacture of a polyimide layer in a film shape was expressed as ∘ and the case of degrading workability due to too low viscosity was expressed as Δ.

Examples 1 to 3, and Comparative Example 2 exhibited a viscosity# of about 5000 CPS to about 5500 CPS measured at a room temperature (about 25° C.) and had good workability. The case of Comparative Example 1 showed a viscosity of about 2000 CPS as an excessively low value, and the case of Comparative Example 3 showed a viscosity of about 1500 CPS and had decreased workability. # The measurement of viscosity was made by maintaining the temperature of a polymer solution (varnish) at 25° C. and using a viscosity meter of BH-II Model available from TOKI SANGYO corporation. RPM was set to be 4 and whether the target of viscosity was embodied was checked by using a spindle number 4.

Hereinafter, the properties of samples in Examples 1 to 3 and Comparative Examples 1 to 3 were measured.

### Examples: Property Evaluation A of Polyimide Layer (Polyimide Film)

(1) Thickness measurement was made by using a digital micrometer 547-401 available from Mitutoyo Japan, at this time, thicknesses of five points randomly placed were measured and the average value thereof was considered as the thickness value.

(2) Light transmittance (%) and haze (%) were measured by using a haze meter NDH-5000W available from Nippon Denshoku corporation in accordance with JIS K 7105 standard.

(3) Yellow index (YI) was measured by using CIE color system of a spectrometer (UltraScan PRO available from Hunter Associates Laboratory). YI was calculated in accordance with ASTM E-313 standard.

(4) CTE (Coefficient of Thermal Expansion) was measured by using a thermal mechanical analyzer, and specifically, Seiko Exstar 6000 (TMA6100) model available from SEICO INST (JAPAN). The measuring method was the same as below, and the variation within the range of 50 to 250 was defined as CTE value based on 2nd Heat.
1st Heating: start at 30° C.→heating at 360° C. (10° C./min↑)→30° C.
2nd Heating: 30° C.→heating at 360° C. (5° C./min↑)

(5) Glass transition temperature (Tg) was measured by using DMA Q800 model available from Texas Instrument, at this time, Tension Mode was used as a measuring mode. The heating speed was 3° C./min and measurement was performed from 25° C. to 450° C., and the frequency of 1 Hz and the amplitude of 20 μm were applied to obtain Tangent delta Tg value.

(6) Adhesion force was measured by the method as follows: A polyimide layer was cured on a glass substrate (G in FIG. 5A and FIG. 5B) based on Amorphous Si, LLO (laser lift off) process was applied to separate the glass substrate and some of a polyimide film, after that, a tape (T in FIG. 5A and FIG. 5B) was fixed to the separated polyimide film, and adhesion force was measured by using UTM (universal testing machine) while peeling off the polyimide layer. 180° Peeling Test was applied as a measuring mode, and the unit for the result was shown by gf/inch. In detail, the speed for pre-test and test was 0.83 mm/sec and the post-test speed was 10 mm/sec. In pre-test, distance to target mode was 10 mm, and the trigger force was 0.001 N.

(7) Residual stress was measured by using a 500 TC (FSM 128) equipment available from Frontier Semiconductor corporation. PI Varnish was applied on a 6-inched silicon wafer, whose “bending degree” was measured previously, by a cotter, and prebaked for 30 minutes at 80° C. Thereafter, a high temperature oven (VF-2000B model manufactured by KOYO LINDBERG) was used to perform heating and curing treatment for 60 minutes at 350° C., while adjusting the concentration of oxygen to be 10 wt ppm in the oven, and thereby a silicon wafer, in which a polyimide resin film with a thickness of 15 μm had been formed, was manufactured. At this time, the difference of bending degree due to the difference in thermal expansion was compared for the silicon wafer and a PI film, and thereby the residual stress was measured.

(8) Measurement of loop stiffness was made by utilizing a loop stiffness tester available from TOYOSEIKI. Referring to FIG. 6A and FIG. 6B, both ends of a polyimide-based film with a width of 15 mm, a length of 120 mm, and a thickness of 50 μm were fixed to the fixing unit LS-T1 of the tester (FIG. 6A), and the polyimide-based film was pressurized at a pressurizing speed of 3.3 mm/s to have the final dislocation distance (L of FIG. 6B) of 20 mm between the pressurizing unit LS-T2 and a fixing unit LS-T1, by moving the pressurizing unit LS-T2 (FIG. 6B). Thereafter, the loop stiffness of the polyimide-based film was measured by using a sensor.

The results of the above measurement were shown in Table 2 below.

TABLE 2

| | | | | Comparative | Comparative | Comparative |
|---|---|---|---|---|---|---|
| | Example 1 | Example 2 | Example 3 | Example 1 | Example 2 | Example 3 |
| Thickness (μm) | 10 | 10 | 10 | 10 | 10 | 10 |
| TT (%) | 89.6 | 90.1 | 89.9 | 89.3 | 89.7 | 89 |
| Haze (%) | 0.4 | 0.5 | 0.3 | 0.4 | 0.5 | 0.5 |
| YI | 5.3 | 4.1 | 3.2 | 7.1 | 5.2 | 5.3 |
| CTE (ppm/° C. | 29.9 | 26.3 | 21.1 | 38.8 | 37.9 | 48.2 |
| Tg (° C.) | 372 | 368 | 381 | 385 | 402 | 352 |
| Adhesion Force (gf/inch) | 235 | 257 | 249 | 405 | 378 | 359 |
| Residual Stress (MPa) | 15.7 | 19 | 17 | 35.2 | 29 | 32 |
| Loop Stiffness (m/N) | 4.06 | 3.72 | 3.22 | 5.23 | 4.8 | 5.1 |
| Heat Resistance Index | 7.92 | 7.36 | 10.62 | 2.82 | 3.66 | 2.28 |
| ° C.²/ppm · MPa* | | | | | | |
| Composite Index | 2.35 | 3.41 | 5.64 | 1.40 | 2.04 | 1.38 |
| ° C.²/ppm * | | | | | | |

*Heat Resistance Index has a value evaluated according to Equation 1 described above.
* Composite Index is a value evaluated according to Equation 2 described above.

Referring to Table 1 and Table 2, the cases of Examples 1 to 3 had a roof stiffness within a range of a proper level, and had flexibility and a suitable recovery force against bending. Therefore, it is confirmed that the Examples 1 to 3 were suitable for being applied as a supporting layer of a foldable or rollable display. Besides, a relatively low coefficient of thermal expansion, a small residual stress, and the like were obtained, and it is confirmed that the Examples were great in all the characteristics including optical characteristics such as yellow index, heat resistance characteristics, and characteristics related to the processability and credibility required to be used as a supporting material, such as adhesion force and residual stress.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

[Acknowledgement] The present application was invented by getting support from Korea Evaluation Institute of Industrial Technology (KEIT) in a technology development project for material parts (Package type with the task number 20007228).

What is claimed is:

1. A film comprising a polyimide layer comprising an aromatic diamine compound residue and an aromatic dianhydride compound residue, wherein the polyimide layer has a loop stiffness value of 3 to 4.5 m/N based on a thickness of the polyimide layer of 50 μm.

2. The film of claim 1, wherein the polyimide layer has a heat resistance stability index (HS index) of 5 to 15° C.²/ppm·MPa according to Equation 1 below:
$$HS index = \frac{Tg \times 10}{H \times RS} \qquad [ Equation 1 ]$$
wherein, in Equation 1, HS index is a heat resistance stability index (° C.²/ppm·MPa), Tg is a glass transition temperature (° C.),H is a coefficient of a thermal expansion value (ppm/° C.) of the polyimide layer, and RS is a residual stress value (MPa) of the polyimide layer.

3. The film of claim 1, wherein the polyimide layer has an adhesion force of 200 gf/inch or more.

4. The film of claim 1, wherein the polyimide layer has a yellow index of 5.3 or less.

5. The film of claim 1, wherein the polyimide layer has a composite index of 2° C.²/ppm or more expressed by Equation 2 below:
$$T Index = \frac{Tg}{H \times Y 1} \qquad [ Equation 2 ]$$
wherein, in Equation 2, T Index is a composite index, Tg is a glass transition temperature (° C.), YI is a yellow index in a thickness of 10 μm of the polyimide layer, and H is a coefficient of thermal expansion (ppm/° C.) value of the polyimide layer.

6. The film of claim 1, wherein the polyimide layer comprises a biphenyltetracarboxylic acid dianhydride residue of 5 to 45 mol, when a total amount of the aromatic dianhydride compound residue is 100 mol.

7. The film of claim 1, wherein the polyimide layer comprises a biphenyltetracarboxylic acid dianhydride residue and a pyromellitic dianhydride residue.

8. The film of claim 7, wherein an amount of the biphenyltetracarboxylic acid dianhydride residue is 15 to 50 mol % based on a sum of numbers of moles of the biphenyltetracarboxylic acid dianhydride residue and pyromellitic dianhydride residue.

9. The film of claim 7, wherein an amount of the pyromellitic dianhydride residue is less than 60 mol % when an amount of the aromatic dianhydride compound residue is 100 mol.

10. A multilayer electronic device comprising a substrate layer and a radiant functional layer, wherein the substrate layer comprises the film of claim 1.

11. A method of manufacturing a film comprising:
preparing a polymer solution by stirring a raw material composition including an aromatic diamine compound and an aromatic dianhydride compound to prepare the polymer solution with a viscosity of 1,000 to 8,000 cps measured at 25° C.;
preparing a sheet by applying the polymer solution in a sheet form and drying the polymer solution with a hot wind to prepare the sheet; and
preparing the film by thermally treating the sheet, wherein the polyimide layer comprises an aromatic diamine compound residue and an aromatic dianhydride compound residue, and
wherein the polyimide layer has a loop stiffness value of 3 to 4.5 m/N based on a thickness of the polyimide layer of 50 μm.

12. The method of claim 11, wherein the film is thermally treated at a temperature of at 360 to 480° C.

13. The method of claim 11, wherein the stirring comprises a primary stirring, a secondary stirring, and a tertiary stirring.

14. The method of claim 13, wherein the primary stirring comprises stirring the aromatic diamine compound and a first aromatic dianhydride compound, and wherein the aromatic diamine compound and the first aromatic dianhydride compound are represented by the following Formula 1 and 2-1, respectively:

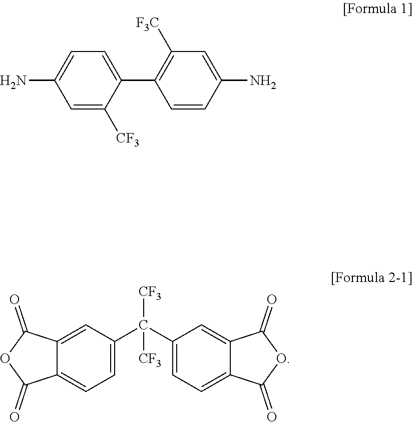 [SMILES: Nc1ccc(-c2ccc(N)cc2C(F)(F)F)c(C(F)(F)F)c1 ; O=C1OC(=O)c2cc(C(c3ccc4c(c3)C(=O)OC4=O)(C(F)(F)F)C(F)(F)F)ccc21]

15. The method of claim 14, wherein the primary stirring is performed for a reaction time of 1 hour to 7 hours at a reaction temperature of 5 to 15° C.

16. The method of claim 14, wherein the secondary stirring comprises stirring a reaction product of the primary stirring and a second aromatic dianhydride compound, wherein the second aromatic dianhydride compound is represented by the following Formula 2-2:

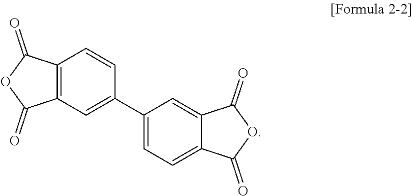 [SMILES: O=C1OC(=O)c2cc(-c3ccc4c(c3)C(=O)OC4=O)ccc21]

17. The method of claim 16, wherein the secondary stirring is performed for a reaction time of 30 minutes to 10 hours at a reaction temperature of 30 to 70° C.

18. The method of claim 16, wherein the tertiary stirring comprises stirring a reaction product of the secondary stirring and a third aromatic dianhydride compound, wherein the third aromatic dianhydride compound is represented by the following Formula 2-3:

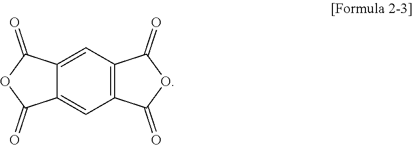 [SMILES: O=c1oc(=O)c2cc3c(=O)oc(=O)c3cc12]

19. The method of claim 18, wherein the tertiary stirring is performed for a reaction time of 30 minutes to 10 hours at a reaction temperature of 30 to 70° C.

20. The method of claim 11, wherein the raw material composition or the polymer solution further comprises a leveling stabilizer.
